(19) United States
(12) Patent Application Publication
(10) Pub. No.: US 2025/0216878 A1
(43) Pub. Date: Jul. 3, 2025

(54) DEEP SLEEP POWER STATE WITH DISABLED INVERSE TEMPERATURE DEPENDENCY VOLTAGE REGULATION

(71) Applicant: Intel Corporation, Santa Clara, CA (US)

(72) Inventors: Yoni Aizik, Haifa (IL); Sagi Weiss, Binyamina (IL); Itai Feit, Ramat Hasharon (IL); Pavel Mikhlin, Raanana (IL); Lisa Algazi, Kfar Saba (IL); Yossi Ben Simon, Karmiel (IL); Nadav Shulman, Tel Mond (IL); Yevgeni Sabin, Haifa (IL)

(73) Assignee: Intel Corporation, Santa Clara, CA (US)

(21) Appl. No.: 18/397,667

(22) Filed: Dec. 27, 2023

(51) Int. Cl. G05F 1/575; G05F 1/567; G06F 1/3237

(52) U.S. Cl. CPC G05F 1/575; G05F 1/567; G06F 1/3237

(57) ABSTRACT

Techniques and mechanisms for providing a power state wherein a temperature-based voltage regulation is disabled. In an embodiment, a load circuit receives one or more clock signals, and one or more supply voltages. Power management logic facilitates either one of a first power state and a second power state, each for providing power to the load circuit. The first power state enables each clock signal provided to the load circuitry, and further comprises an enabled state of a functionality to perform inverse temperature dependency voltage regulation. The second power state disables each clock signal provided to the load circuitry, and further comprises a disabled state of the functionality. In another embodiment, during the second power state, each voltage supply provided to the load circuit is regulated in a respective voltage range which enables at least some state of the load circuit to be maintained.

### BACKGROUND

### 1. Technical Field

This disclosure generally relates to power management and more particularly, but not exclusively, to a power state wherein an inverse temperature dependent voltage regulation functionality is disabled.

### 2. Background Art

In today's technological world, performances of electronics devices are improving at a rapid pace, with a rapid increase in their computing power. With this increase, the devices are becoming power hungry, i.e., consuming more power. To save power, a processor in a device may enter in a sleep mode (e.g., low power state) during brief periods of inactivity.

For example, the Advanced Configuration and Power Interface (ACPI) specification (e.g., version 3.0a released on Dec. 30, 2005) co-developed by Hewlett-Packard®, Intel®, Microsoft®, Phoenix®, and Toshiba® defines various power states (e.g., processor power states C0-C3 during normal G0/S0 working state of the device) in ACPI-compatible systems. According to the ACPI specification, C0 state may be the normal execution state of the processor. However, while in C1 state during brief period of inactivity, the processor may not execute instructions, but can return to an executing state almost instantaneously, whereas in C3 state (which is a deeper sleep state compared to C1, and saves more power than C1), the processor's caches may maintain state but ignore any snoops. The processor may take longer time to return to a normal executing state (C0) from the C3 state as compared to returning from C1 state. Variations on the each of the states, including the C3 state (e.g., deep sleep, deeper sleep, etc.), that may differ in how deep the processor sleeps (i.e., what functionalities of the processor is disabled to save power) and how long it takes to wake up, is also possible.

Conventional power management, including those defined by the ACPI standard, may be performed based on heuristics collected on the processor and guidance given by the operating system, and a power management algorithm may look at past processor activities to predict future activity. For example, the operating system may look at the central processing unit utilization to provide this guidance. Based on these factors, the processor may enter into one of a plurality of sleep states. Although a processor may intermittently enter into a low power state, other platform components with a longer wake-up time may not usually enter into any such low power state to ensure better performance.

As successive generations of integrated circuitry continue to scale in size, functionality and power efficiency, there is expected to be an increasing premium placed on improvements to power management for such integrated circuitry.

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a system to selectively implement a deep sleep state according to an embodiment.

FIG. 2 shows a flow diagram illustrating features of a method to determine a state of power delivery to a load circuit according to an embodiment.

FIG. 3 shows a block diagram illustrating features of a processor to operate in a deep sleep power state according to an embodiment.

FIG. 4 shows a timing diagram illustrating a transition to a deep sleep power state according to an embodiment.

FIG. 5 shows a timing diagram illustrating a transition from a deep sleep power state according to an embodiment.

FIG. 6 illustrates an exemplary system.

FIG. 7 illustrates a block diagram of an example processor that may have more than one core and an integrated memory controller.

FIG. 8A is a block diagram illustrating both an exemplary in-order pipeline and an exemplary register renaming, out-of-order issue/execution pipeline according to examples.

FIG. 8B is a block diagram illustrating both an exemplary example of an in-order architecture core and an exemplary register renaming, out-of-order issue/execution architecture core to be included in a processor according to examples.

### DETAILED DESCRIPTION

Embodiments discussed herein variously provide techniques and mechanisms for providing a low power state wherein a temperature-based voltage regulation functionality is disabled. In some embodiments, power management logic—e.g., comprising hardware, firmware, executing software and/or any of various suitable combinations thereof—is operable to provide a sleep state, during which at least some voltage regulation, according to an inverse temperature dependency (“ITD”) scheme, is disabled. Unless otherwise indicated, “inverse temperature dependency,” “inverse temperature dependent,” “ITD,” “ITD voltage regulation functionality,” and related terms variously refer herein to a characteristic of voltage regulation, wherein—at least within some range of possible levels of a given temperature—a given voltage (e.g., that of a voltage supply rail) is regulated in a negative relation to that temperature.

In an illustrative scenario according to one embodiment, while a ITD voltage regulation functionality (or, for brevity, simply “ITD functionality” herein) is enabled, an indication of a first change to the given temperature is to result in a second change to a regulated voltage, wherein a sign of the first change is to be opposite a sign of the second change. For example, a level of the regulated voltage is to be decreased, according to an ITD scheme, based on an increase to the temperature. Alternatively or in addition, a level of the regulated voltage is increased, according to the same ITD scheme, based on a decrease to the temperature. In one such embodiment, the voltage change is based at least in part on an indication of the temperature changing to be in a temperature range to which ITD scheme applies (e.g., wherein the temperature changes from a level which is also within the temperature range or, alternatively, changes from a level which is outside of the temperature range). A power state which includes an ITD functionality being enabled is referred to herein as an “ITD-enabled power state.” By contrast, the term “ITD-disabled power state” refers herein to a power state which includes an ITD functionality being disabled.

In various embodiments, an ITD-disabled power state is provided for some load circuitry, such as some or all circuits of a packaged device, an integrated circuit (IC) chip—e.g., comprising a system-on-chip (SoC)—and/or the like. In one such embodiment, each clock signal which is provided to the load circuitry is disabled during the ITD-disabled power state. Furthermore, for each of the one or more voltage rails which power the load circuitry, the rail is maintained in a respective voltage range during the ITD-disabled power state—e.g., wherein a lowest voltage level of the respective voltage range is at or above a respective threshold minimum voltage level for maintaining some state of the load circuitry. However, in some embodiments at least one voltage rail continues to enable operation of the logic (e.g., that of a p-unit, a PMU, or the like) which manages the ITD-disabled power state. In an illustrative scenario according to one embodiment, a first rail to power some or all of the load circuitry is maintained at a first voltage level at some point during the ITD-disabled power state, wherein the first rail would otherwise be changed to a higher voltage level, but for the disabled state of the ITB functionality.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including circuitry to manage a delivery of power.

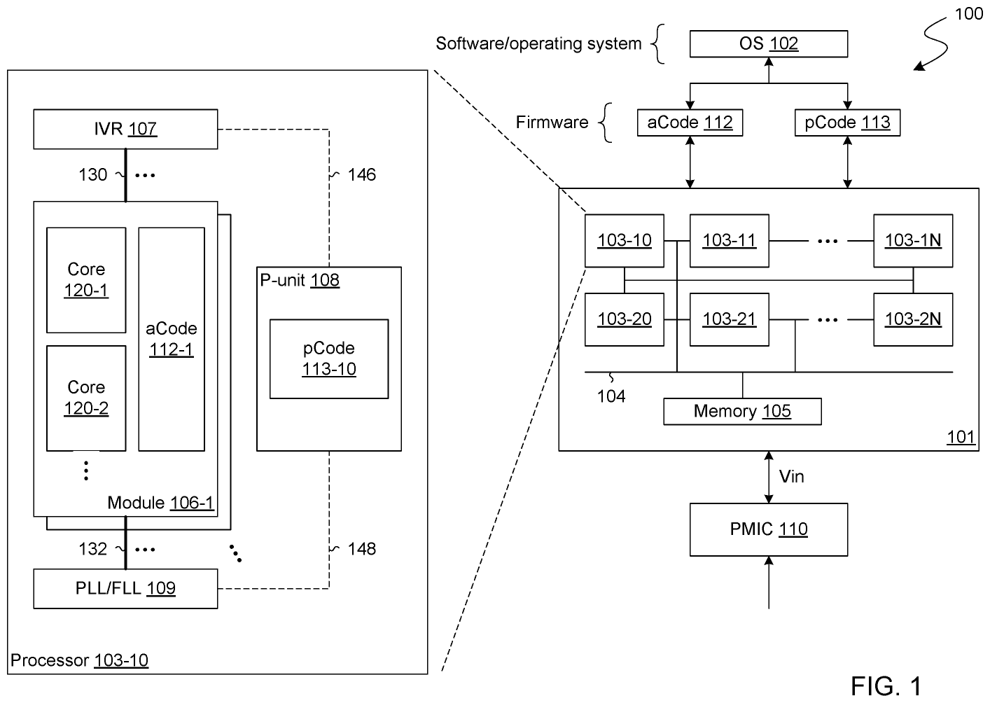

FIG. 1 shows a system 100 which selectively implements a deep sleep state according to an embodiment. System 100 illustrates features of one example embodiment which is operable to disable an ITD functionality to facilitate a state of low power consumption by some load circuitry. In one such embodiment, each clock signal which is provided to the load circuitry is disabled during the power state. Furthermore, for each of the one or more voltage rails which power the load circuitry, the rail is maintained in a respective voltage range during the power state, wherein a lowest voltage level of the respective voltage range is at or above a respective threshold minimum voltage level for maintaining some state of the load circuitry.

As shown in FIG. 1, system 100 comprises processor hardware 101 which is coupled to provide, or otherwise operate with, an operating system (OS) 102. Some embodiments provide an interface between OS 102 and processor hardware 101—e.g., with one or more mode set registers (MSRs), with memory mapped input output (MMIO) mechanisms, or the like. For example, some embodiments provide a software interface through which a virtual machine orchestration layer, a hypervisor, or other authorized software agent is able to define a bound on an acceptable variability (including no variability, for example) to a frequency of a processor core. For example, such an interface enables a cloud service provider (CSP), or other suitable agent, to enforce power delivery rules—e.g., according to the terms of a service level agreement (SLA)—wherein power management hardware of a processor module configures itself to implement said power delivery rules. By way of illustration and not limitation, the interface includes, or is exposed by, or otherwise operates based on one or more mode set registers (MSRs), one or more designated vendor-specific extended capabilities (DVSEC) interfaces, or the like.

In one such embodiment, one or more power delivery rules are programmed via a software interface on a per-module level of granularity. Accordingly, a CSP (or other such agency) is able to mix different types of software instances—e.g., for different respective tenants—in the same system on chip (SoC). For example, the CSP is able to program various power bounds and/or voltage bounds (e.g., each based on respective SLA) for a given one or more modules and/or for one or more respective conditions. In one such embodiment, a power control unit (p-unit) in the SoC translates a defined power delivery rule into one or more threshold power levels, voltage levels and/or the like, and sends such one or more threshold levels to a processor module which is to selectively suspend or otherwise throttle instruction execution—e.g., on a core-specific basis, a per-module basis, and/or the like—based on the one or more threshold levels.

Processor hardware 101 comprises one or more processors 103 (in the example embodiment shown, the individually labeled processors 103_10 through 103_1N, and 103_20 through 103_2N, where ‘N’ is a number), a fabric 104 connecting the processor 103, and a memory 105. In some embodiments, a given processor 103 is a die, dielet, or chiplet. Here the term “die” generally refers to a single continuous piece of semiconductor material (e.g. silicon) which have variously formed therein or thereon transistors and/or other components which, for example, make up multiple processor cores. In some embodiments, a given multi-core processor has two or more processors on a single die or, alternatively, the two or more processors are provided on two or more respective dies. In some embodiments, each processor module (and/or each processor die, for example) has a dedicated power controller or power control unit (p-unit) power controller or power control unit (p-unit) which can be dynamically or statically configured as a supervisor or supervisee. In some examples, dies are of the same size and functionality i.e., wherein said dies comprise symmetric cores. However, dies can also be asymmetric. For example, some dies have different size and/or function than other dies. In some embodiments, a given processor 103 is a dielet or chiplet. Here the term “dielet” or “chiplet” generally refers to a physically distinct semiconductor die, typically connected to an adjacent die in a way that allows the fabric across a die boundary to function like a single fabric rather than as two distinct fabrics. Thus at least some dies are dielets, in various embodiments. For example, a given dielet includes one or more p-units which can be dynamically or statically configured as a supervisor, supervisee or both.

In some embodiments, fabric 104 is a collection of interconnects or a single interconnect that allows the various dies to communicate with one another. Here the term “fabric” generally refers to communication mechanism having a known set of sources, destinations, routing rules, topology and other properties. The sources and destinations may be any type of data handling functional unit such as power management units. Fabrics can be two-dimensional spanning along an x-y plane of a die and/or three-dimensional (3D) spanning along an x-y-z plane of a stack of vertical and horizontally positioned dies. A single fabric spans multiple dies, in some embodiments. A fabric can take any of various suitable topologies such as a mesh topology, star topology, daisy chain topology, or the like. A fabric is part of a network-on-chip (NoC) with multiple agents, in some embodiments. These agents can be any of various suitable functional units.

In some embodiments, some or all of the one or more processor 103 each includes a respective one or more processor modules which each comprises a plurality of processor cores. One such example is illustrated with reference to processor 103_10. In this example, processor 103_10 includes one or more modules, such as the illustrative modules 106-1 through 106-M shown (where M is a positive integer). For the sake of simplicity, a processor module is referred by the general label 106. In this example, module 106-1 includes one or more cores (such as the illustrative cores 120-1 and 120-2 shown). For the sake of simplicity, a core of module 106-1 is referred by the general label 120.

Here, the term “processor core” generally refers to an independent execution unit that can run one program thread at a time in parallel with other cores. In some embodiments, a given processor core includes a dedicated power controller or power control unit (p-unit) which can be dynamically or statically configured as a supervisor or supervisee. This dedicated p-unit is also referred to as an autonomous p-unit, in some examples. In some examples, all processor cores are of the same size and functionality i.e., symmetric cores. However, processor cores can also be asymmetric. For example, some processor cores have different size and/or function than other processor cores. A processor core can be a virtual processor core or a physical processor core. Processor 103_10 includes an integrated voltage regulator (IVR) 107, power control unit (p-unit) 108, phase locked loop (PLL) and/or frequency locked loop (FLL) 109. The various blocks of processor 103_10 are coupled via an interface or fabric. Here, the term “interconnect” refers to a communication link, or channel, between two or more points or nodes. It comprises one or more separate conduction paths such as wires, vias, waveguides, passive components, and/or active components. It also comprises a fabric, in some embodiments. In some embodiments, p-unit 108 is coupled to OS 102 via an interface. Here the term “interface” generally refers to software and/or hardware used to communicate with an interconnect. An interface includes logic and I/O driver/receiver to send and receive data over the interconnect or one or more wires.

In some embodiments, each processor 103 is coupled to a power supply via voltage regulator. For example, the voltage regulator is internal to processor hardware 101 (e.g., on the package of processor hardware 101) or external to processor hardware 101. In some embodiments, each processor 103 includes IVR 107 that receives a primary regulated voltage from the voltage regulator of processor hardware 101 and generates an operating voltage for the agents of processor 103. By way of illustration and not limitation, IVR 107 of processor 103-10 is operable to regulate one or more voltages which are provided—via one or more rails (e.g., including the illustrative rail 130 shown)—to module 106-1 and/or other load circuitry of processor 103-10. In one such embodiment, such agents of processor 103 include some or all of the various components of processor 103 including modules 106 (and, for example, the cores 120 thereof), IVR 107, p-unit 108, and PLL/FLL 109. In various embodiments, modules 106 share IVR 107 (or, in other embodiments, are each provided a different respective IVR of processor 103-10).

Accordingly, an implementation of IVR 107 allows for fine-grained control of voltage and thus power and performance of each individual module 106. As such, each module 106 can operate at an independent voltage and frequency, enabling great flexibility and affording wide opportunities for balancing power consumption with performance. In some embodiments, the use of multiple IVRs enables the grouping of components into separate power planes, such that power is regulated and supplied by the IVR to only those components in the group. For example, during power management, a given power domain is able to be powered down or off with IVR 107 when module 106-1 is placed into a certain low power state, while another such module 106 remains active, or fully powered. As such, IVR 107 is operable to control a certain domain of a logic or module 106. Here the term “domain” generally refers to a logical or physical perimeter that has similar properties (e.g., supply voltage, operating frequency, type of circuits or logic, and/or workload type) and/or is controlled by a particular agent. For example, a domain is a group of logic units or function units that are controlled by a particular supervisor. Such a domain is sometimes referred to as an Autonomous Perimeter (AP). By way of illustration and not limitation, a domain comprises an entire system-on-chip (SoC) or part of the SoC, and is governed by a p-unit, in some embodiments.

In some embodiments, a given processor 103 includes its own p-unit 108. P-unit 108 controls the power and/or performance of processor 103. For example, p-unit 108 controls power and/or performance (e.g., instructions per cycle, frequency, or the like) of each individual module 106. In various embodiments, p-unit 108 of each processor 103 is coupled via fabric 104. As such, respective p-units 108 of the processors 103 communicate—for example, with one another and OS 102—to determine the optimal power state of processor hardware 101 by controlling power states of individual modules 106 under their respective domains.

In an embodiment, p-unit 108 includes circuitry including hardware, software and/or firmware to perform power management operations with regard to processor 103. In some embodiments, p-unit 108 provides control information to voltage regulator of processor hardware 101 via an interface to cause the voltage regulator to generate the appropriate regulated voltage. In some embodiments, p-unit 108 provides control information to IVR 107 (and, in some embodiments, to additional voltage regulator logic of modules 106) via another interface to control the operating voltage generated (or to cause a corresponding IVR to be disabled in a low power mode). In some embodiments, p-unit 108 includes a variety of power management logic units to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software). In some embodiments, p-unit 108 is implemented as a microcontroller. The microcontroller can be an embedded microcontroller which is a dedicated controller or as a general-purpose controller. In some embodiments, p-unit 108 is implemented as a control logic configured to execute its own dedicated power management code, here referred to as pCode. In some embodiments, power management operations to be performed by p-unit 108 may be implemented externally to a processor 103, such as by way of a separate power management integrated circuit (PMIC) or other component external to processor hardware 101. In yet other embodiments, power management operations to be performed by p-unit 108 may be implemented within BIOS or other system software. In some embodiments, p-unit 108 of a processor 103 may assume a role of a supervisor or supervisee.

Here the term “supervisor” generally refers to a power controller, or power management, unit (a “p-unit”), which monitors and manages power and performance related parameters for one or more associated power domains, such as one or more processor modules, either alone or in cooperation with one or more other p-units. Examples of power/performance related parameters include, but are not limited to, domain power, platform power, voltage, voltage domain current, die current, load-line, temperature, device latency, utilization, clock frequency, processing efficiency, current/future workload information, and other parameters. In various embodiments, a supervisor receives, calculates, searches for or otherwise determines one or more new power or performance constraints (limits, average operational, etc.) for one or more domains. In one such embodiment, these one or more constraints are then communicated to one or more supervisee p-units, or directly to controlled or monitored agents, such as modules 106, via one or more fabrics and/or interconnects. By way of illustration and not limitation, a supervisor learns of the workload (present and future) of one or more dies, power measurements of the one or more dies, and other parameters (e.g., platform level power boundaries) and determines new performance constraints for the one or more dies. These performance constraints are then communicated by supervisor p-units to the supervisee p-units via one or more fabrics and/or interconnect. In examples where a die has one p-unit, a supervisor (Svor) p-unit is also referred to as supervisor die.

Here the term “supervisee” generally refers to a power controller, or power management, unit (a “p-unit”), which monitors and manages power and performance related parameters for one or more associated power domains, either alone or in cooperation with one or more other p-units and receives instructions from a supervisor to set power and/or performance parameters (e.g., supply voltage, operating frequency, maximum current, throttling threshold, etc.) for its associated power domain. In examples where a die has one p-unit, a supervisee (Svee) p-unit may also be referred to as a supervisee die. Note that a given p-unit is operable to serve either as a Svor, a Svee, or both a Svor/Svee p-unit, in various embodiments.

In various embodiments, p-unit 108 executes a firmware (referred to as pCode and/or aCode) that communicates with OS 102. In various embodiments, a given processor 103 includes a PLL or FLL 109 that, for example, generates a clock signal for p-unit 108 and one or more other clock signals (such as the illustrative clock signal 132 shown) for some or all modules 106 of processor 103-10. For example, modules 106 include or are otherwise associated with independent clock generation circuitry such as one or more PLLs to control operating frequency of each module 106 independently. In some embodiments, an input supply is received by a PMIC (power management integrated circuit) 110 which provides a regulated supply Vin to processor hardware 101. In some embodiments, Vin is used as input supply by local voltage regulator(s) to generate local supplies for one or more domains.

In some embodiments, each module 106 includes a p-unit that executes aCode, a firmware to manage core-level performance. In this example, module 106-1 includes a p-unit that executes aCode 112-1 to manage respective power states of the cores 120 of module 106-1. In some embodiments, pCode 113-10 of p-unit 108 communicates with aCode 112-1. The aCode associated with a given processor module can communicate with a local p-unit of that processor module, and/or with a supervisor p-unit which is external to that processor module.

In some embodiments, p-unit 108 and/or the local p-unit that execute aCode 112-1 implement an adaptive or dynamic power management scheme (hardware and/or software) that dynamically adjusts one or more operational characteristics including, for example, an operational frequency, a supply voltage and/or the like. In one such embodiment, the power management scheme dynamically adjusts some or all operational characteristics on core-specific basis (i.e., at a core level of granularity). Alternatively or in addition, the power management scheme dynamically adjusts an operational frequency, and/or a supply voltage on a per-module basis (i.e., at a module level of granularity).

In some embodiments, power management logic of module 106-1 monitors telemetry such as a rate of instruction executions, a type of instruction executions, and/or the like—over a number of cycles (e.g., 64, 100, 2000, etc. cycles)—for one of cores 120. Additionally or alternatively, power management logic of module 106-1 monitors one or more indicia of a thermal state of system 100—e.g., wherein system 100 includes, is coupled to, or otherwise operates based on one or more thermal sensors (not shown). Based on such telemetry and/or thermal state, power management logic (provided, for example, with p-unit 108, aCode 112-1, and/or local logic at the one of cores 120) determines whether execution by the one of cores 120 is to be throttled or, alternatively, whether one or more power state transitions are to be performed each with a respective load circuit (e.g., including one or more of cores 120).

In an illustrative scenario according to one embodiment, an external software (or other) agent provides to processor 103-10 an indication of a power delivery rule which is to be enforced on one or more of the modules 106. By way of illustration and not limitation, the power delivery rule is provided to pCode 113-10 (or other suitable logic of p-unit 108) by aCode 112, pCode 113 and/or any of various other suitable resources which are external to processor 103-10. In an embodiment, the power delivery rule is defined in a service level agreement (SLA) such as one with a cloud service provider (CSP) or other such entity. In some embodiments, a given power delivery rule specifies or otherwise indicates one or more “power demand conditions”—i.e., each such condition comprising a respective one or more characteristics of a demand for power by a given load circuit. A power demand condition comprises, for example, a frequency variability, a latency, a core performance, a workload (actual or expected future) and/or any of various other key performance indicators (KPIs) such as one which is dependent on, or otherwise indicative of, an operational frequency of a core. Alternatively, a power demand condition comprises a thermal condition during a delivery of power to the load circuitry in question.

Furthermore, the given power delivery rule specifies or otherwise indicates, for each of the one or more power demand conditions, a respective power state which is to be implemented based on an indication of the power demand condition in question. For example, a power delivery rule identifies a power demand condition and a corresponding ITD-disabled power state which is to be implemented in the event of said power demand condition. Based on an indication of a power delivery rule, p-unit 108 (for example, pCode 113-10 of p-unit 108) performs a calculation, look-up and/or any of various other suitable operations to identify one or more threshold values which are to be used for evaluating operational characteristics of cores 120 (and/or any other load circuitry). For example, pCode 113-10 identifies, for each of one or more possible power states of cores 120, a different respective test criteria which includes or is otherwise based on a corresponding one or more power demand conditions. In one such embodiment, when cores 120 are each in a particular power state, evaluation of instruction execution by the cores 120 is to take place based on a current test criteria which includes a corresponding threshold value. Based on such evaluation, some embodiments variously select between power management options comprising (for example) a power state transition option.

For example, such a power state transition comprises p-unit 108 providing one or more communications—such as the illustrative control signal 146 shown—to indicate that, for each of one or more rails (e.g., including rail 130), IVR 107 is to change a level of the voltage at said rail. In some embodiments, the power state transition comprises p-unit 108 additionally or alternatively providing one or more communications—such as the illustrative control signal 148 shown—to indicate that, for each of one or more clock signals (e.g., including clock signal 132), PLL/FLL 109 is to disable, enable or otherwise change said clock signal. In various embodiments, the power state transition comprises p-unit 108 additionally or alternatively changing an internal configuration state (or alternatively, signaling external hardware, firmware and/or software logic) to disable an ITD functionality such as one which is a basis for voltage regulation using IVR 107.

In various embodiments, an ITD-disabled power state is to be selectively provided for load circuitry which (for example) comprises only one module, or multiple modules, or any of various sub-portions of one or more modules of processor hardware 101. In other embodiments, the ITD-disabled power state is provided for any of various types of load circuits—e.g., including at least some load circuitry of a processor comprising additional or alternative fabric architectures, or load circuitry of a single core processor (for example).

In the example embodiment shown, an ITD-disabled power state is selectively implemented using control signals 146, 148 with which p-unit 108 controls IVR 107 and PLL/FLL 109, wherein p-unit 108 disables (or enables) an ITD functionality. However, in other embodiments, such power state management functionality is implemented at least in part with logic which, instead, is at least partially outside of p-unit 108—e.g., with one or more other resources of processor 103-10 (and/or with one or more other resources outside of processor 103-10).

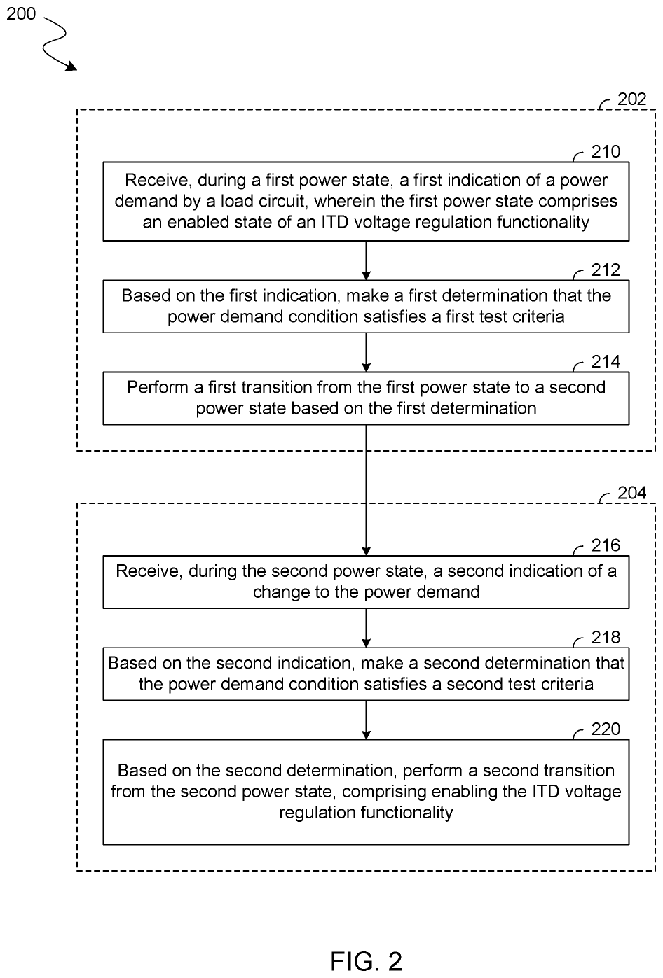

FIG. 2 shows a method 200 for determining a state of power delivery to a load circuit according to an embodiment. Method 200 illustrates one example of an embodiment which transitions to or from an ITD-disabled power state. Operations such as those of method 200 are performed with any of various combinations of suitable hardware (e.g., circuitry), firmware and/or executing software which, for example, provide some or all of the functionality of p-unit 108 and/or other suitable logic of system 100

In some embodiments, method 200 comprises operations 202 which transition power management circuitry (and/or other suitable logic) from an ITD-enabled state of power delivery to an ITD-disabled state of power delivery. For example, as shown in FIG. 2, operations 202 comprise (at 210) receiving a first indication of a power demand by a load circuit. The first indication is received during a first power state for delivering power to the load circuit. In an embodiment, one or more voltage rails each supply to the load circuit a respective supply voltage—e.g., wherein one or more clock signals are also provided to the load circuit. In one such embodiment, the first power state comprises an enabled state of a functionality to regulate, according to an ITD scheme, some or all of the one or more supply voltages provided to the load circuit.

When enabled, the ITD voltage regulation functionality is to change a given first supply voltage, of the one or more supply voltages, based on an indication of a change to a temperature of the load circuit—e.g., wherein the voltage change is to have an opposite sign to that of the indicated temperature change. By way of illustration and not limitation, the ITD voltage regulation functionality is to increase such a first supply voltage based on an indication of a decrease to a temperature of the load circuit. Alternatively or in addition, the ITD voltage regulation functionality is to decrease the first supply voltage based on an indication of an increase to the temperature.

Based on the first indication received at 210, operations 202 (at 212) make a first determination that the power demand condition satisfies a first test criteria. In some embodiments, the first determination made at 212 identifies (for example) that each core of the load circuitry is or will be down, each graphics processor is or will be down, all storage media is or will be down, and/or the like. For example, operations 202 detect that an actual (or expected future) decrease to a workload, performed with the load circuit, enables the load circuit to be operated in a sleep state (or other suitable low power state) wherein the ITD voltage regulation functionality is disabled.

For example, based on the first determination made at 212, operations 202 (at 214) perform a first transition from the first power state to a second power state which is to deliver power to the load circuit. In an embodiment, performing the first transition at 214 comprises disabling the ITD voltage regulation functionality, as well as disabling the one or more clock signals, and transitioning the one or more supply voltages each to a respective voltage range which enables a state of the load circuit to be maintained.

In various embodiments, the one or more supply voltages continue to be regulated during the second power state—e.g., wherein each such supply voltage to be maintained within its respective lower power (“sleep state”) voltage range. However, during the second power state, an ITD scheme is omitted as a basis for such regulation. For example, during the second power state, circuitry to perform additional voltage regulation based on the ITD scheme is turned off or otherwise disabled for additional power savings. In one such embodiment, such circuitry, when enabled, is to monitor one or more indicia of a thermal state, to perform evaluations based on the indicia and one or more test conditions, to identify a voltage regulation action based on the evaluations, and/or to communicate or otherwise implement the identified action.

In various embodiments, performing the first transition at 214 comprises disabling each clock signal which is provided to the load circuit, wherein—after each such clock signal is disabled—each supply voltage which is provided to the load circuit is transitioned to a respective voltage range which enables a state of the load circuit to be maintained.

By way of illustration and not limitation, in some embodiments, the load circuit comprises a processor core, wherein during the second power state, each supply voltage provided to the load circuit is in a respective range which enables an execution state of the processor core to be maintained, but which prevents further execution of instructions by the processor core.

In various embodiments, a power management circuit performs the first transition at 214, wherein the power management circuit continues to receive power and operate during the second power state. For example, during the second power state, the power management circuit receives a relatively high supply voltage—e.g., as compared to the supply voltage(s) provided to the load circuit—via a voltage rail other than any voltage rail which provides a supply voltage to the load circuit.

In various embodiments, method 200 additionally or alternatively comprises operations 204 which transition power delivery from an ITD-disabled power state to an ITD-enabled power state. In one such embodiment, operations 202 comprise (at 216) receiving a second indication of a change to the power demand, wherein the second indication is received during the second power state. In some embodiments, the second indication specifies or otherwise indicates one or more thermal conditions of a type similar to that indicated by the first indication.

Based on the second indication received at 216, operations 204 (at 218) make a second determination that the changed power demand condition of the load circuit satisfies a second test criteria. For example, an actual or expected future workload of the load circuit is determined to be one which requires a functionality—e.g., an instruction execution functionality—for which ITD voltage regulation is required or otherwise preferred.

Based on the second determination made at 218, operations 204 (at 220) perform a second transition from the second power state (e.g., to the first power state or some other ITD-enabled power state). In an embodiment, performing the second transition at 220 comprises enabling the ITD voltage regulation functionality. In some embodiments, performing the second transition at 220 further comprises enabling the one or more clock signals, which are provided to the load circuit, as well as increasing each of the one or more supply voltages.

In an illustrative scenario according to one embodiment, the load circuit comprises a processor core, wherein performing the second transition at 220 comprises enabling each clock signal which is provided to the load circuit. In one such embodiment, the second transition further comprises, after each clock signal which is provided to the load circuit is enabled, transitioning each supply voltage which is provided to the load circuit to a respective voltage range which enables an execution of instructions by the processor core. In an alternate embodiment, performing the second transition comprises transitioning from the second power state to a third power state, wherein during the third power state, each of the one or more clock signals provided to the load circuit remains disabled.

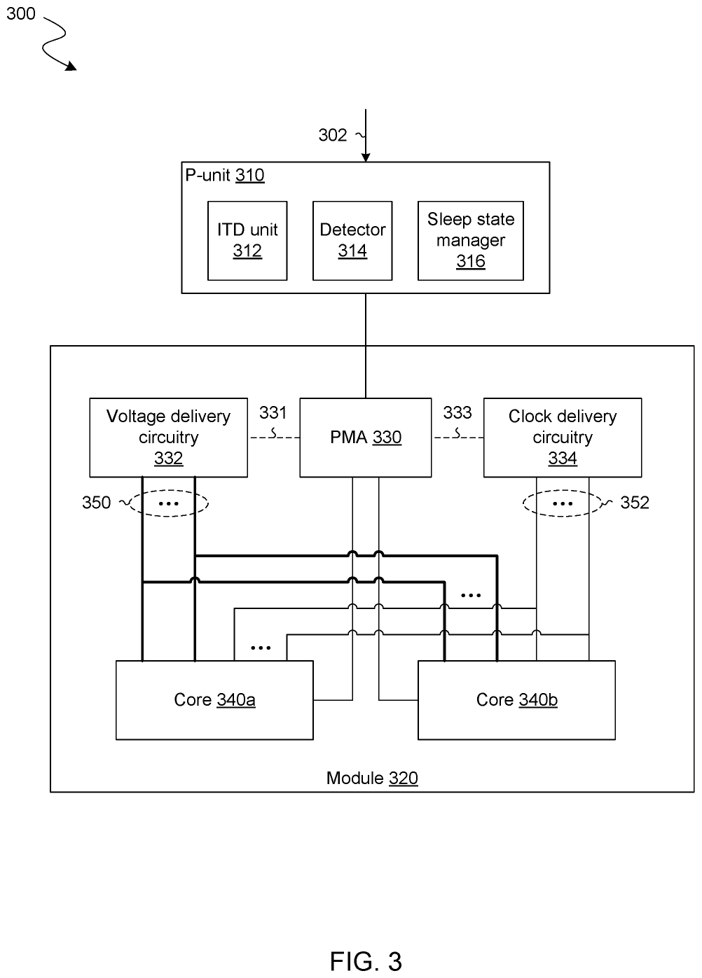

FIG. 3 shows a processor 300 which supports operation in a deep sleep power state according to an embodiment. Processor 300 illustrates features of one example embodiment which is operable to transition to or from a ITD-disabled power state. In some embodiments, processor 300 provides functionality such as that of a processor 103 (for example)—e.g., wherein operations of method 200 are performed with some or all of processor 300.

As shown in FIG. 3, processor 300 comprises a p-unit 310 and one or more processor modules (e.g., comprising the illustrative module 320 shown) coupled thereto, wherein p-unit 310 is coupled to receive information comprising one or more power delivery rules and/or information which specifies or otherwise indicates one or more power demand conditions. Based on such information, load circuitry of module 320 is monitored to determine whether a power state transition is to be performed. In various embodiments, such monitoring is to evaluate, for each of one or more cores, whether, according to a given power delivery rule, a current (or expected future) power demand condition satisfies a test criteria for providing a corresponding power state.

In the example embodiment shown, module 320 comprises voltage delivery circuitry 332, a power management agent (PMA) 330, a clock delivery circuitry 334, and one or more cores comprising (for example) a cores 340a and 340b. Voltage delivery circuitry 332 is coupled to receive a first supply voltage from a voltage regulator (not shown)—such as IVR 107, for example—which is external to module 320. In one such embodiment, voltage delivery circuitry 332 is coupled to provide one or more supply voltages to power load circuitry of module 320, wherein the one or more voltages are based on the first supply voltage. By way of illustration and not limitation, voltage delivery circuitry 332 is coupled to one or more voltage rails (e.g., including the illustrative rails 350 shown) which are each to provide a respective voltage based on the first voltage.

Furthermore, clock delivery circuitry 334 is coupled to receive a first clock signal from a clock source (not shown)—such as PLL/FLL 109, for example—which is external to module 320. In one such embodiment, clock delivery circuitry 334 is coupled to provide one or more clock signals (such as the illustrative clock signals 352 shown) to facilitate operations of the load circuitry, wherein the one or more clock signals are based on the first clock signals. Accordingly, load circuitry of one or both of cores 340a, 340b (and/or any other cores of module 320, for example) share a power delivery domain which includes a common one or more supply voltages and a common one or more clock signals which, in some embodiments, correspond to a common one or more operational frequencies.

In one such embodiment, p-unit 310 (or other suitable logic of processor 300) comprises logic, such as the illustrative ITD unit 312 shown, which is operable to perform voltage regulation according to an ITD scheme. Furthermore, p-unit 310 comprises hardware, firmware and/or other suitable logic (such as the illustrative sleep state manager 316) to selectively implement any of one or more power states of module 320—e.g., wherein the one or more power states comprise an ITD-disabled power state. For example, sleep state manager 316 is operable to selectively disable (or enable) some or all of the functionality of ITD unit 312.

In an illustrative scenario according to one embodiment, p-unit 310 receives an indication 302 of a power delivery rule which specifies or otherwise indicates one or more power demand conditions, and one or more power states which each correspond to (e.g., which are to be implemented each based on) a different respective power demand condition of the the one or more power demand conditions. In an embodiment, the one or more power states comprises an ITD-disabled power state.

For example, indication 302 is provided to p-unit 310 by any of various suitable hardware resources, firmware resources, or executing software resources, such as a resource which provides functionality of aCode 112, pCode 113 or the like. In one such embodiment, p-unit 310 provides functionality (such as that of p-unit 108, for example) to identify one or more test criteria based on indication 302—e.g., wherein each of the one or more test criteria corresponds to a respective power state which is to be made available to cores 340a, 340b. For example, p-unit 310 performs any of various look-up, calculation and/or other suitable operations to identify a given test criteria based on a power delivery rule. Based on such operations, p-unit 310 configures a detector 314 to identify or otherwise detect an instance of one or more power demand conditions which satisfy the given test criteria.

For example, PMA 330 comprises circuitry to monitor operational characteristics of some or all load circuitry of module 320 (such as circuitry of core 340a and/or core 340b). Based on such monitoring, PMA 330 communicates to detector 314 information which specifies or otherwise indicates a current one or more power demand conditions of the load circuitry. With said information, detector 314 determines whether the indicated power demand condition satisfies a test criteria which, according to a power delivery rule, corresponds to a particular power state (such as an ITD-disabled power state).

In an illustrative scenario according to one embodiment, detector 314 signals sleep state manager 316 (based on the information from PMA 330) to implement a power state transition which corresponds to the satisfied test criteria. For example, detector 314 indicates to sleep state manager 316 that some or all of module 320 is to be transitioned to a sleep state (such as an ITD-disabled power state) or, alternatively, away from said sleep state.

By way of illustration and not limitation, in some embodiments, a first transition of module 320 to an ITD-disabled power state comprises sleep state manager 316 signaling to clock delivery circuitry 334 (e.g., via PMA 330 and a control signal 333 therefrom) that clock signals 352 are each to be disabled. Furthermore, the first transition of module 320 comprises sleep state manager 316 signaling to voltage delivery circuitry 332 (e.g., via PMA 330 and a control signal 331 therefrom) that the respective supply voltages on rails 350 are to be reduced or otherwise regulated each to remain in a respective voltage range which, for example, is able to maintain state of the load circuitry, but which also prevents instruction execution and/or other higher power functionality of the load circuitry. For example, rails 350 are to be variously transitioned to respective low voltage ranges after clock signals 352 are each disabled. Further still, the first transition of module 320 comprises sleep state manager 316 signaling to ITD unit 312 that ITD functionality is to be disabled.

In some embodiments, a second transition of module 320 from an ITD-disabled power state comprises sleep state manager 316 signaling to ITD unit 312 that ITD functionality is to be enabled. Although some embodiments are not limited in this regard, the second transition of module 320 further comprises (for example) sleep state manager 316 directly or indirectly signaling to clock delivery circuitry 334 that clock signals 352 are each to be enabled. In one such embodiment, the second transition of module 320 further comprises sleep state manager 316 directly or indirectly signaling to voltage delivery circuitry 332 that one or more of the respective supply voltages on rails 350 are to be increased or otherwise regulated each to deliver power for maintaining state of the load circuitry and (for example) for further enabling instruction execution and/or other higher power functionality of the load circuitry. For example, rails 350 are to be variously transitioned to respective high voltage ranges after clock signals 352 are each enabled.

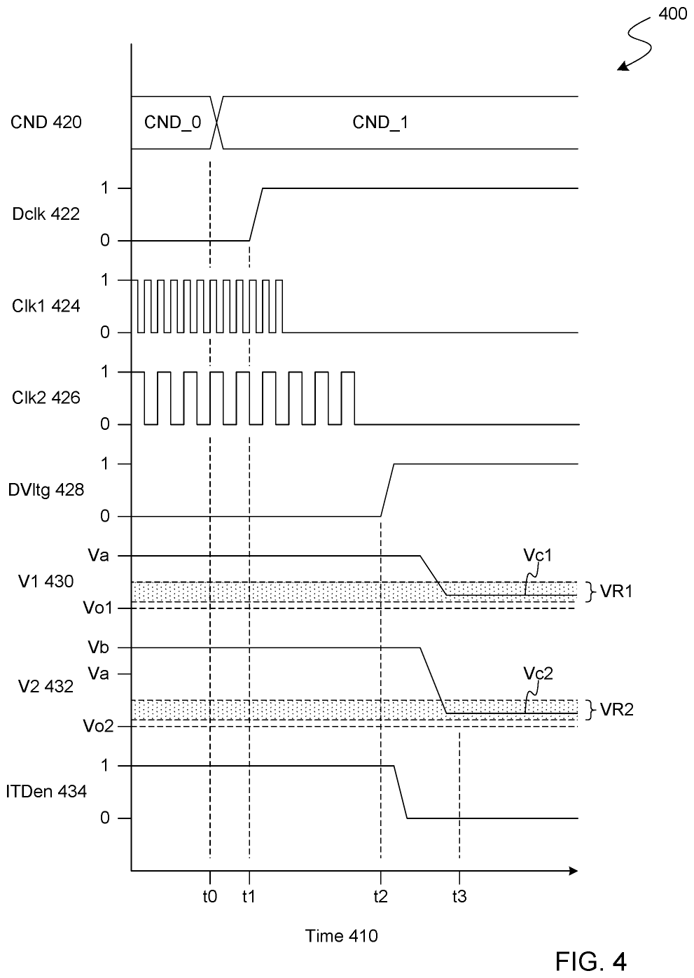

FIG. 4 shows a timing diagram 400 which illustrates a transition to a deep sleep power state according to an embodiment. Timing diagram 400 demonstrates features of one example embodiment which, over a period of time 410, implements an ITD-disabled power state for at least some load circuitry such as that of a processor, a system-on-chip, a packaged device and/or the like. Operations such as those which are illustrated in timing diagram 400 are performed (for example) with logic of system 100 or processor 300—e.g., wherein method 200 is based on (for example, includes), or results in, such operations.

As shown in FIG. 4, timing diagram 400 illustrates features of state information (CND) 420 which specifies or otherwise indicates a current or expected future power demand condition. For example, CND 420 includes, or is otherwise based on, monitor information which specifies or otherwise indicates an amount of work (if any) to be performed with the load circuitry. Timing diagram 400 further illustrates features of a control signal (Dclk) 422 which, in some embodiments, is to selectively enable or disable each clock signal which is provided to the load circuitry. Furthermore, timing diagram 400 illustrates features of two such clock signals—i.e., clock signal Clk1 424 and clock signal Clk2 426—which, in the example embodiment shown, are each provided to the load circuitry.

Further still, timing diagram 400 illustrates features of another control signal (DVltg) 428 which, in some embodiments, is to selectively enable or disable, for each supply voltage which is provided to the load circuitry, a respective required range in which the supply voltage is to be maintained (e.g., the required range to maintain a state of at least some data and/or other information at the load circuitry). Timing diagram 400 further illustrates features of two such supply voltages—i.e., supply voltage V1 430, and supply voltage V2 432—which, in the example embodiment shown, are each provided to the load circuitry via a respective voltage rail. Furthermore, timing diagram 400 illustrates features of a control signal (ITDen) 434 to selectively enable or disable an ITD voltage regulation functionality—e.g., a functionality to regulate V1 430 and/or V2 432 according to an ITD scheme.

In an illustrative scenario according to one embodiment, state information CND 420 transitions, at a time t0, from indicating a power demand condition CND_0 of the load circuitry, to instead indicating a different power demand condition CND_1 of the load circuitry. For example, the indication of power demand condition CND_0 is based on a need for a functionality of the load circuitry, wherein the functionality requires some minimum amount of power to be delivered. By way of illustration and not limitation, the load circuitry comprises one or more processor cores, wherein CND 420 indicates the condition CND_0 based on a need for instruction execution by some or all of the one or more processor cores. By contrast, CND 420 indicates the condition CND_1 based on a determination that such a functionality of the load circuitry is not needed, or will not be needed.

Based on the indication of condition CND_1 by CND 420, power management logic participates in operations to implement a transition from an ITD-enabled power state to an ITD-disabled power state. By way of illustration and not limitation, the power management logic asserts Dclk 422, at time t1, to disable each clock signal which is provided to the load circuitry. Based on the assertion of Dclk 422, each of the clock signals Clk1 424 and Clk2 426 is quiesced or otherwise disabled.

After each clock signal for the load circuitry have been disabled, the power management logic further asserts DVltg 428, at time t2, so that each supply voltage provided to the load circuitry—i.e., including V1 430 and V2 432—is decreased or otherwise changed to be maintained in a respective low voltage range. For each such supply voltage, the respective low voltage range enables a state of at least some data and/or other information to be maintained at the load circuitry. However, in some embodiments, the respective low voltage range also disables instruction execution and/or some other functionality of the load circuitry.

In the example embodiment shown, assertion of DVltg 428 results in V1 430 being decreased from a voltage level Va (which, for example, facilitates instruction execution) to another voltage level Vc1 which is in a low voltage range VR1. In one such embodiment, a lowest voltage level of the voltage range VR1 is greater than (or equal to) a minimum threshold voltage level Vo1 which is required to maintain state that the load circuitry

Alternatively or in addition, assertion of DVltg 428 results in V2 432 being decreased from a similar voltage level Vb to another voltage level Vc2 which is in a low voltage range VR2. In one such embodiment, a lowest voltage level of the voltage range VR2 is greater than (or equal to) a minimum threshold voltage level Vo2 which is required to maintain state that the load circuitry. During the ITD-disabled power state (e.g., after time t3), supply voltages V1 430 and V2 432 are regulated to be maintained in respective voltage ranges VR1, VR2, wherein such voltage regulation is independent of an ITD scheme which (for example) was a basis for voltage regulation prior to time t0.

In an embodiment, transitioning to the ITD-disabled state further comprises the power management circuitry deasserting ITDen 434 to disable or otherwise prevent any voltage regulation which is according to an ITD scheme. In the example embodiment shown, ITDen 434 is deasserted before a time t3 when each supply voltage provided to the load circuitry has been transitioned to the respective low voltage range. For example, ITDen 434 is disabled in time to prevent ITD-based regulation while V1 430 and/or V2 432 is being decreased in response to the assertion of DVltg 428.

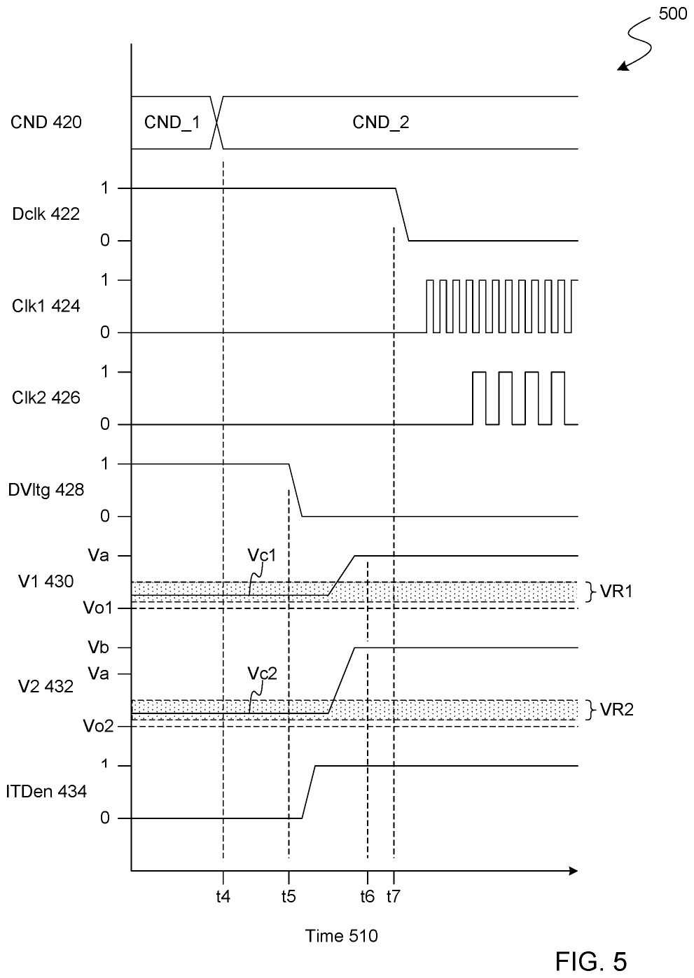

FIG. 5 shows a timing diagram 500 which illustrates a transition from a deep sleep power state according to an embodiment. Timing diagram 500 demonstrates features of one example embodiment which, over a period of time 510, implements an ITD-enabled power state for at least some load circuitry. To illustrate certain features of various embodiments, timing diagram 500 shows a power state transition which is implemented with information, signals, and supply voltages which are also represented in timing diagram 400.

In an illustrative scenario according to one embodiment, state information CND 420 transitions, at a time t4, from indicating power demand condition CND_1, to instead indicating a different power demand condition CND_2 of the load circuitry. In some embodiments, the indication of power demand condition CND_2 is based on a need for a functionality of the load circuitry, wherein the functionality requires some minimum amount of power to be delivered. For example, the condition CND_2 is the same as (or alternatively, is different than) condition CND_0.

Based on the indication of condition CND_2 by CND 420, power management logic participates in operations to implement a transition from an ITD-disabled power state to an ITD-enabled power state. For example, the power management logic deasserts DVltg 428, at time t5, so that each supply voltage provided to the load circuitry is increased or otherwise changed to be above its respective low voltage range. In the example embodiment shown, deassertion of DVltg 428 results in V1 430 being increased from the voltage level Vc1 in voltage range VR1 to a voltage level Va which (for example) facilitates instruction execution and/or other such functionality. Alternatively or in addition, deassertion of DVltg 428 results in V2 432 being increased from the voltage level Vc2 in voltage range VR2 to a voltage level Vb which facilitates instruction execution and/or other such functionality. In an embodiment, transitioning to the ITD-disabled state further comprises the power management circuitry asserting ITDen 434 to reenable voltage regulation according to an ITD scheme.

After each of the one or more supply voltages has been reenabled (e.g., by the time t6 shown), the power management logic further deasserts Dclk 422, at time t7, to enable each clock signal which is provided to the load circuitry. Based on the deassertion of Dclk 422, each of the clock signals Clk1 424 and Clk2 426 is reenabled.

### Exemplary Computer Architectures.

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

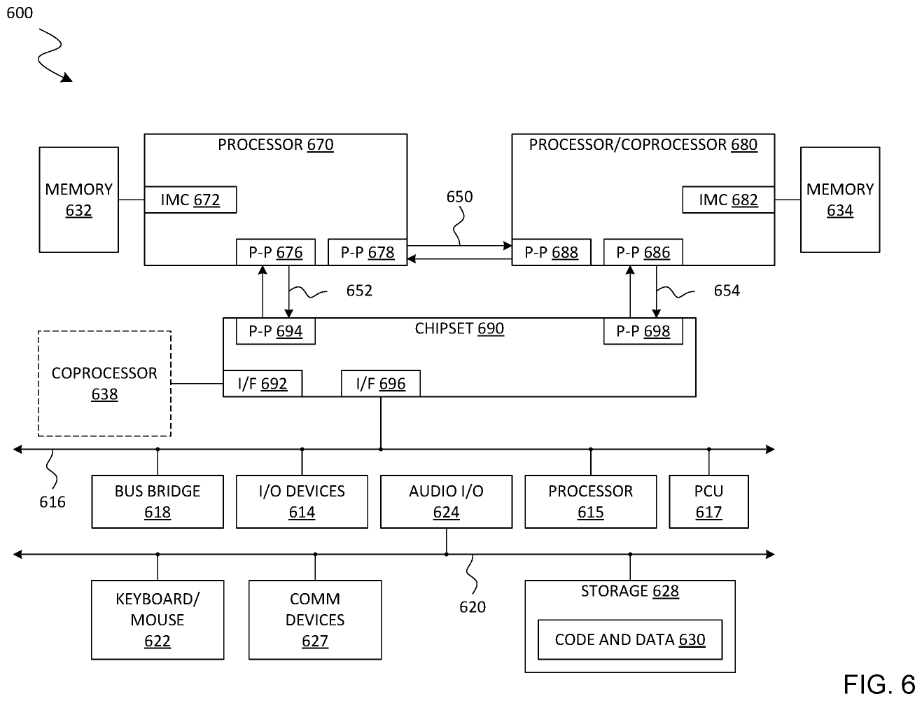

FIG. 6 illustrates an exemplary system. Multiprocessor system 600 is a point-to-point interconnect system and includes a plurality of processors including a first processor 670 and a second processor 680 coupled via a point-to-point interconnect 650. In some examples, the first processor 670 and the second processor 680 are homogeneous. In some examples, first processor 670 and the second processor 680 are heterogenous. Though the exemplary system 600 is shown to have two processors, the system may have three or more processors, or may be a single processor system.

Processors 670 and 680 are shown including integrated memory controller (IMC) circuitry 672 and 682, respectively. Processor 670 also includes as part of its interconnect controller point-to-point (P-P) interfaces 676 and 678; similarly, second processor 680 includes P-P interfaces 686 and 688. Processors 670, 680 may exchange information via the point-to-point (P-P) interconnect 650 using P-P interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a chipset 690 via individual P-P interconnects 652, 654 using point to point interface circuits 676, 694, 686, 698. Chipset 690 may optionally exchange information with a coprocessor 638 via an interface 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via P-P interconnect, such that either or both processors' local cache information may be stored in the shared cache if a processor is placed into a low power mode.

Chipset 690 may be coupled to a first interconnect 616 via an interface 696. In some examples, first interconnect 616 may be a Peripheral Component Interconnect (PCI) interconnect, or an interconnect such as a PCI Express interconnect or another I/O interconnect. In some examples, one of the interconnects couples to a power control unit (PCU) 617, which may include circuitry, software, and/or firmware to perform power management operations with regard to the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interconnect 616, along with a bus bridge 618 which couples first interconnect 616 to a second interconnect 620. In some examples, one or more additional processor(s) 615, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 616. In some examples, second interconnect 620 may be a low pin count (LPC) interconnect. Various devices may be coupled to second interconnect 620 including, for example, a keyboard and/or mouse 622, communication devices 627 and a storage circuitry 628. Storage circuitry 628 may be one or more non-transitory machine-readable storage media as described below, such as a disk drive or other mass storage device which may include instructions/code and data 630 in some examples. Further, an audio I/O 624 may be coupled to second interconnect 620. Note that other architectures than the point-to-point architecture described above are possible. For example, instead of the point-to-point architecture, a system such as multiprocessor system 600 may implement a multi-drop interconnect or other such architecture.

### Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

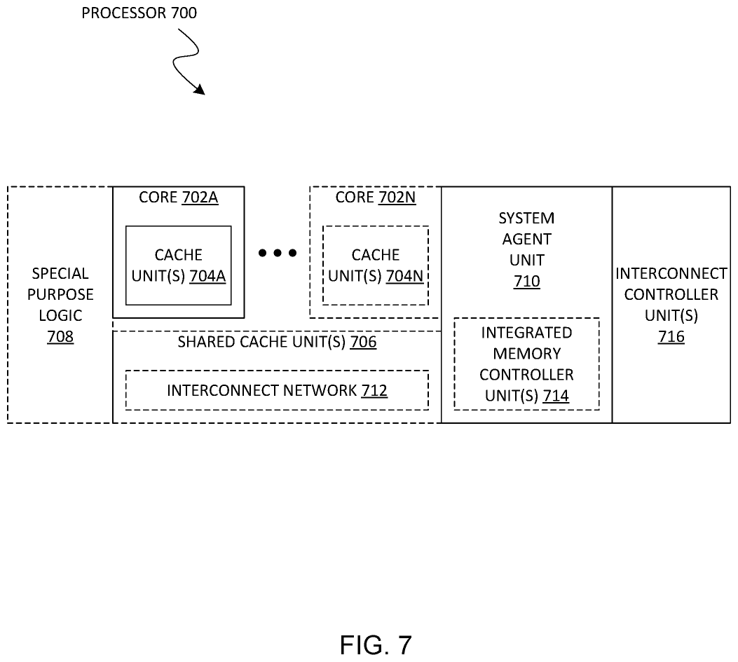

FIG. 7 illustrates a block diagram of an example processor 700 that may have more than one core and an integrated memory controller. The solid lined boxes illustrate a processor 700 with a single core 702A, a system agent unit circuitry 710, a set of one or more interconnect controller unit(s) circuitry 716, while the optional addition of the dashed lined boxes illustrates an alternative processor 700 with multiple cores 702A-N, a set of one or more integrated memory controller unit(s) circuitry 714 in the system agent unit circuitry 710, and special purpose logic 708, as well as a set of one or more interconnect controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702A-N being one or more general purpose cores (e.g., general purpose in-order cores, general purpose out-of-order cores, or a combination of the two); 2) a coprocessor with the cores 702A-N being a large number of special purpose cores intended primarily for graphics and/or scientific (throughput); and 3) a coprocessor with the cores 702A-N being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704A-N within the cores 702A-N, a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples ring-based interconnect network circuitry 712 interconnects the special purpose logic 708 (e.g., integrated graphics logic), the set of shared cache unit(s) circuitry 706, and the system agent unit circuitry 710, alternative examples use any number of well-known techniques for interconnecting such units. In some examples, coherency is maintained between one or more of the shared cache unit(s) circuitry 706 and cores 702A-N.

In some examples, one or more of the cores 702A-N are capable of multi-threading. The system agent unit circuitry 710 includes those components coordinating and operating cores 702A-N. The system agent unit circuitry 710 may include, for example, power control unit (PCU) circuitry and/or display unit circuitry (not shown). The PCU may be or may include logic and components needed for regulating the power state of the cores 702A-N and/or the special purpose logic 708 (e.g., integrated graphics logic). The display unit circuitry is for driving one or more externally connected displays.

The cores 702A-N may be homogenous in terms of instruction set architecture (ISA). Alternatively, the cores 702A-N may be heterogeneous in terms of ISA; that is, a subset of the cores 702A-N may be capable of executing an ISA, while other cores may be capable of executing only a subset of that ISA or another ISA.

### Exemplary Core Architectures—In-Order and Out-of-Order Core Block Diagram.

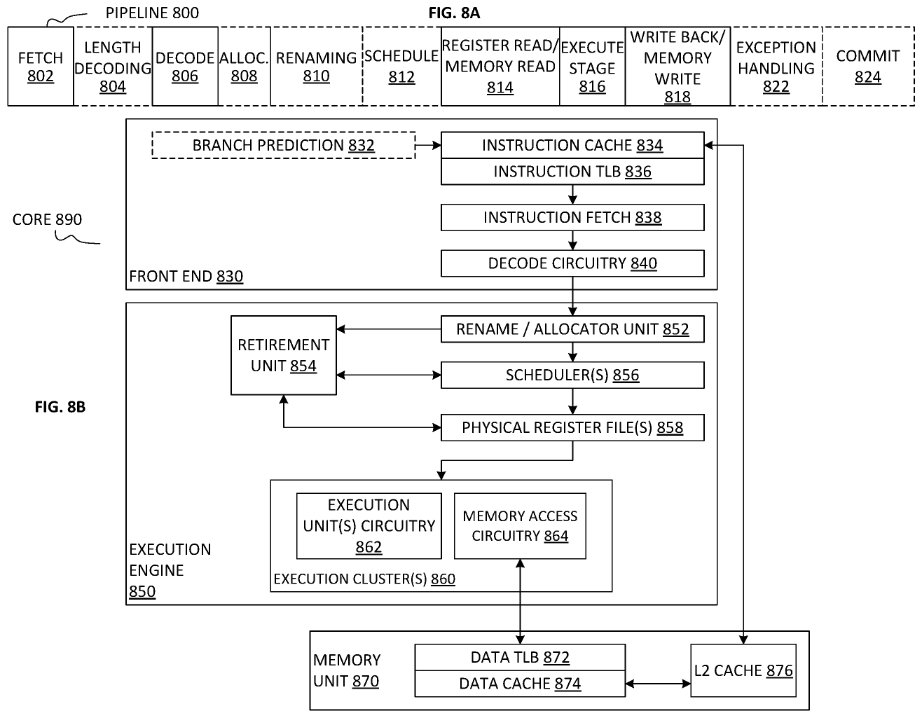

FIG. 8A is a block diagram illustrating both an exemplary in-order pipeline and an exemplary register renaming, out-of-order issue/execution pipeline according to examples. FIG. 8B is a block diagram illustrating both an exemplary example of an in-order architecture core and an exemplary register renaming, out-of-order issue/execution architecture core to be included in a processor according to examples. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 8B may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8B shows a processor core 890 including front-end unit circuitry 830 coupled to an execution engine unit circuitry 850, and both are coupled to a memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end unit circuitry 830 may include branch prediction circuitry 832 coupled to an instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various different mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to a retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, arithmetic generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to a data cache circuitry 874 coupled to a level 2 (L2) cache circuitry 876. In one exemplary example, the memory access circuitry 864 may include a load unit circuitry, a store address unit circuit, and a store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, a level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Techniques and architectures for mitigating power consumption by circuitry are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

In one or more first embodiments, a device comprises detector circuitry to receive a first indication of a power demand by a load circuit, wherein one or more voltage rails are each to supply to the load circuit a respective supply voltage of one or more supply voltages, one or more clock signals are each provided to the load circuit, and the first indication is received during a first power state to deliver power to the load circuit, wherein the first power state comprises an enabled state of a functionality to regulate, according to an inverse temperature dependency (ITD) scheme, some or all of the one or more supply voltages, the detector circuitry further to make a first determination, based on the first indication, that a power demand condition satisfies a first test criteria, and power management circuitry to perform, based on the first determination, a first transition from the first power state to a second power state, wherein the power management circuitry to perform the first transition comprises the power management circuitry disable the functionality, to disable the one or more clock signals, and to transition the one or more supply voltages each to a respective voltage range which enables a state of the load circuit to be maintained.

In one or more second embodiments, further to the first embodiment, when enabled, the functionality is to increase a first supply voltage of the one or more supply voltages based on an indication of a decrease to a temperature of the load circuit, and decrease the first supply voltage based on an indication of an increase to the temperature.

In one or more third embodiments, further to the first embodiment or the second embodiment, during the second power state, the power management circuitry is to receive power via a first voltage rail other than any voltage rail which is to provide a voltage to the load circuit.

In one or more fourth embodiments, further to any of the first through third embodiments, the power management circuitry to perform the first transition comprises the power management circuitry to disable each clock signal which is provided to the load circuit, and after each clock signal which is provided to the load circuit is disabled, transition each supply voltage which is provided to the load circuit to a respective voltage range which enables a state of the load circuit to be maintained.

In one or more fifth embodiments, further to the fourth embodiment, the load circuit comprises a processor core, and during the second power state, each supply voltage which is provided to the load circuit is to be in a respective voltage range which enables an execution state of the processor core to be maintained, and which further prevents an execution of instructions by the processor core.

In one or more sixth embodiments, further to any of the first through third embodiments, the detector circuitry is further to receive a second indication of a change to the power demand, wherein the second indication is received during the second power state, the detector circuitry is further to make a second determination, based on the second indication, that the power demand condition satisfies a second test criteria, and based on the second determination, the power management circuitry is further to perform a second transition from the second power state, wherein the power management circuitry to perform the second transition comprises the power management circuitry to enable the functionality.

In one or more seventh embodiments, further to the sixth embodiment, the power management circuitry to perform the second transition further comprises the power management circuitry to enable the one or more clock signals, and increase each of the one or more supply voltages.

In one or more eighth embodiments, further to the seventh embodiment, the load circuit comprises a processor core, and the power management circuitry to perform the second transition comprises the power management circuitry to transition each supply voltage which is provided to the load circuit to a respective voltage range which enables an execution of instructions by the processor core, and after each supply voltage which is provided to the load circuit is transitioned to the respective voltage range, enable each clock signal which is provided to the load circuit.

In one or more ninth embodiments, further to the seventh embodiment, the power management circuitry to perform the second transition comprises the power management circuitry to transition from the second power state to a third power state, and during the third power state, each of the one or more clock signals is disabled.

In one or more tenth embodiments, one or more non-transitory computer-readable storage media having stored thereon instructions which, when executed by one or more processing units, cause the one or more processing units to perform a method comprising receiving a first indication of a power demand by a load circuit, wherein one or more voltage rails are each to supply to the load circuit a respective supply voltage of one or more supply voltages, wherein one or more clock signals are each provided to the load circuit, wherein the first indication is received during a first power state to deliver power to the load circuit, and wherein the first power state comprises an enabled state of a functionality to regulate, according to an inverse temperature dependency (ITD) scheme, some or all of the one or more supply voltages, making a first determination, based on the first indication, that a power demand condition satisfies a first test criteria, based on the first determination, performing a first transition from the first power state to a second power state, wherein performing the first transition comprises disabling the functionality, disabling the one or more clock signals, and transitioning the one or more supply voltages each to a respective voltage range which enables a state of the load circuit to be maintained.

In one or more eleventh embodiments, further to the tenth embodiment, when enabled, the functionality is to increase a first supply voltage of the one or more supply voltages based on an indication of a decrease to a temperature of the load circuit, and decrease the first supply voltage based on an indication of an increase to the temperature.

In one or more twelfth embodiments, further to the tenth embodiment or the eleventh embodiment, performing the first transition comprises disabling each clock signal which is provided to the load circuit, and after each clock signal which is provided to the load circuit is disabled, transitioning each supply voltage which is provided to the load circuit to a respective voltage range which enables a state of the load circuit to be maintained.

In one or more thirteenth embodiments, further to the twelfth embodiment, the load circuit comprises a processor core, and during the second power state, each supply voltage which is provided to the load circuit is in a respective voltage range which enables an execution state of the processor core to be maintained, and which further prevents an execution of instructions by the processor core.

In one or more fourteenth embodiments, further to any of the tenth through twelfth embodiments, the method further comprises receiving a second indication of a change to the power demand, wherein the second indication is received during the second power state, making a second determination, based on the second indication, that the power demand condition satisfies a second test criteria, and based on the second determination, performing a second transition from the second power state, wherein performing the second transition comprises enabling the functionality.

In one or more fifteenth embodiments, further to the fourteenth embodiment, performing the second transition further comprises enabling the one or more clock signals, and increasing each of the one or more supply voltages.

In one or more sixteenth embodiments, further to the fifteenth embodiment, the load circuit comprises a processor core, and performing the second transition comprises transitioning each supply voltage which is provided to the load circuit to a respective voltage range which enables an execution of instructions by the processor core, and after each supply voltage which is provided to the load circuit is transitioned to the respective voltage range, enabling each clock signal which is provided to the load circuit.

In one or more seventeenth embodiments, further to the fifteenth embodiment, performing the second transition comprises transitioning from the second power state to a third power state, and during the third power state, each of the one or more clock signals is disabled.

In one or more eighteenth embodiments, a system comprises a load circuit comprising one or more processor cores, detector circuitry coupled to receive a first indication of a power demand by the load circuit, wherein one or more voltage rails are each to supply to the load circuit a respective supply voltage of one or more supply voltages, one or more clock signals are each provided to the load circuit, and the first indication is received during a first power state to deliver power to the load circuit, wherein the first power state comprises an enabled state of a functionality to regulate, according to an inverse temperature dependency (ITD) scheme, some or all of the one or more supply voltages, the detector circuitry further to make a first determination, based on the first indication, that a power demand condition satisfies a first test criteria, and power management circuitry to perform, based on the first determination, a first transition from the first power state to a second power state, wherein the power management circuitry to perform the first transition comprises the power management circuitry disable the functionality, to disable the one or more clock signals, and to transition the one or more supply voltages each to a respective voltage range which enables a state of the load circuit to be maintained, and a network interface coupled to the load circuit, the network interface to receive and transmit data over a network.

In one or more nineteenth embodiments, further to the eighteenth embodiment, when enabled, the functionality is to increase a first supply voltage of the one or more supply voltages based on an indication of a decrease to a temperature of the load circuit, and decrease the first supply voltage based on an indication of an increase to the temperature.

In one or more twentieth embodiments, further to the eighteenth embodiment or the nineteenth embodiment, during the second power state, the power management circuitry is to receive power via a first voltage rail other than any voltage rail which is to provide a voltage to the load circuit.

In one or more twenty-first embodiments, further to any of the eighteenth through twentieth embodiments, the power management circuitry to perform the first transition comprises the power management circuitry to disable each clock signal which is provided to the load circuit, and after each clock signal which is provided to the load circuit is disabled, transition each supply voltage which is provided to the load circuit to a respective voltage range which enables a state of the load circuit to be maintained.

In one or more twenty-second embodiments, further to the twenty-first embodiment, during the second power state, each supply voltage which is provided to the load circuit is to be in a respective voltage range which enables an execution state of the processor core to be maintained, and which further prevents an execution of instructions by the one or more processor cores.

In one or more twenty-third embodiments, further to any of the eighteenth through twentieth embodiments, the detector circuitry is further to receive a second indication of a change to the power demand, wherein the second indication is received during the second power state, the detector circuitry is further to make a second determination, based on the second indication, that the power demand condition satisfies a second test criteria, and based on the second determination, the power management circuitry is further to perform a second transition from the second power state, wherein the power management circuitry to perform the second transition comprises the power management circuitry to enable the functionality.

In one or more twenty-fourth embodiments, further to the twenty-third embodiment, the power management circuitry to perform the second transition further comprises the power management circuitry to enable the one or more clock signals, and increase each of the one or more supply voltages.

In one or more twenty-fifth embodiments, further to the twenty-fourth embodiment, the power management circuitry to perform the second transition comprises the power management circuitry to transition each supply voltage which is provided to the load circuit to a respective voltage range which enables an execution of instructions by the processor core, and after each supply voltage which is provided to the load circuit is transitioned to the respective voltage range, enable each clock signal which is provided to the load circuit.

In one or more twenty-sixth embodiments, further to the twenty-fourth embodiment, the power management circuitry to perform the second transition comprises the power management circuitry to transition from the second power state to a third power state, and during the third power state, each of the one or more clock signals is disabled.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A device comprising:
detector circuitry to receive a first indication of a power demand by a load circuit, wherein:
one or more voltage rails are each to supply to the load circuit a respective supply voltage of one or more supply voltages, one or more clock signals are each provided to the load circuit; and
the first indication is received during a first power state to deliver power to the load circuit, wherein the first power state comprises an enabled state of a functionality to regulate, according to an inverse temperature dependency (ITD) scheme, some or all of the one or more supply voltages;
the detector circuitry further to make a first determination, based on the first indication, that a power demand condition satisfies a first test criteria; and
power management circuitry to perform, based on the first determination, a first transition from the first power state to a second power state, wherein the power management circuitry to perform the first transition comprises the power management circuitry disable the functionality, to disable the one or more clock signals, and to transition the one or more supply voltages each to a respective voltage range which enables a state of the load circuit to be maintained.

2. The device of claim 1, wherein, when enabled, the functionality is to:
increase a first supply voltage of the one or more supply voltages based on an indication of a decrease to a temperature of the load circuit; and
decrease the first supply voltage based on an indication of an increase to the temperature.

3. The device of claim 1, wherein:
during the second power state, the power management circuitry is to receive power via a first voltage rail other than any voltage rail which is to provide a voltage to the load circuit.

4. The device of claim 1, wherein the power management circuitry to perform the first transition comprises the power management circuitry to:
disable each clock signal which is provided to the load circuit; and
after each clock signal which is provided to the load circuit is disabled, transition each supply voltage which is provided to the load circuit to a respective voltage range which enables a state of the load circuit to be maintained.

5. The device of claim 4, wherein:
the load circuit comprises a processor core; and
during the second power state, each supply voltage which is provided to the load circuit is to be in a respective voltage range which enables an execution state of the processor core to be maintained, and which further prevents an execution of instructions by the processor core.

6. The device of claim 1, wherein:
the detector circuitry is further to receive a second indication of a change to the power demand, wherein the second indication is received during the second power state;
the detector circuitry is further to make a second determination, based on the second indication, that the power demand condition satisfies a second test criteria; and
based on the second determination, the power management circuitry is further to perform a second transition from the second power state, wherein the power management circuitry to perform the second transition comprises the power management circuitry to enable the functionality.

7. The device of claim 6, wherein the power management circuitry to perform the second transition further comprises the power management circuitry to:
enable the one or more clock signals; and
increase each of the one or more supply voltages.

8. The device of claim 7, wherein:
the load circuit comprises a processor core; and
the power management circuitry to perform the second transition comprises the power management circuitry to:
transition each supply voltage which is provided to the load circuit to a respective voltage range which enables an execution of instructions by the processor core; and
after each supply voltage which is provided to the load circuit is transitioned to the respective voltage range, enable each clock signal which is provided to the load circuit.

9. The device of claim 7, wherein:
the power management circuitry to perform the second transition comprises the power management circuitry to transition from the second power state to a third power state; and
during the third power state, each of the one or more clock signals is disabled.

10. One or more non-transitory computer-readable storage media having stored thereon instructions which, when executed by one or more processing units, cause the one or more processing units to perform a method comprising:
receiving a first indication of a power demand by a load circuit, wherein one or more voltage rails are each to supply to the load circuit a respective supply voltage of one or more supply voltages, wherein one or more clock signals are each provided to the load circuit, wherein the first indication is received during a first power state to deliver power to the load circuit, and wherein the first power state comprises an enabled state of a functionality to regulate, according to an inverse temperature dependency (ITD) scheme, some or all of the one or more supply voltages;
making a first determination, based on the first indication, that a power demand condition satisfies a first test criteria;
based on the first determination, performing a first transition from the first power state to a second power state, wherein performing the first transition comprises disabling the functionality, disabling the one or more clock signals, and transitioning the one or more supply voltages each to a respective voltage range which enables a state of the load circuit to be maintained.

11. The one or more computer-readable storage media of claim 10, wherein performing the first transition comprises:
disabling each clock signal which is provided to the load circuit; and
after each clock signal which is provided to the load circuit is disabled, transitioning each supply voltage which is provided to the load circuit to a respective voltage range which enables a state of the load circuit to be maintained.

12. The one or more computer-readable storage media of claim 11, wherein:
the load circuit comprises a processor core; and
during the second power state, each supply voltage which is provided to the load circuit is in a respective voltage range which enables an execution state of the processor core to be maintained, and which further prevents an execution of instructions by the processor core.

13. The one or more computer-readable storage media of claim 10, the method further comprising:
receiving a second indication of a change to the power demand, wherein the second indication is received during the second power state;
making a second determination, based on the second indication, that the power demand condition satisfies a second test criteria; and
based on the second determination, performing a second transition from the second power state, wherein performing the second transition comprises enabling the functionality.

14. The one or more computer-readable storage media of claim 13, wherein performing the second transition further comprises:
enabling the one or more clock signals; and
increasing each of the one or more supply voltages.

15. The one or more computer-readable storage media of claim 14, wherein:
the load circuit comprises a processor core; and
performing the second transition comprises:
transitioning each supply voltage which is provided to the load circuit to a respective voltage range which enables an execution of instructions by the processor core; and
after each supply voltage which is provided to the load circuit is transitioned to the respective voltage range, enabling each clock signal which is provided to the load circuit.

16. A system comprising:
a load circuit comprising one or more processor cores;
detector circuitry coupled to receive a first indication of a power demand by the load circuit, wherein:
one or more voltage rails are each to supply to the load circuit a respective supply voltage of one or more supply voltages, one or more clock signals are each provided to the load circuit; and
the first indication is received during a first power state to deliver power to the load circuit, wherein the first power state comprises an enabled state of a functionality to regulate, according to an inverse temperature dependency (ITD) scheme, some or all of the one or more supply voltages;
the detector circuitry further to make a first determination, based on the first indication, that a power demand condition satisfies a first test criteria; and
power management circuitry to perform, based on the first determination, a first transition from the first power state to a second power state, wherein the power management circuitry to perform the first transition comprises the power management circuitry disable the functionality, to disable the one or more clock signals, and to transition the one or more supply voltages each to a respective voltage range which enables a state of the load circuit to be maintained; and
a network interface coupled to the load circuit, the network interface to receive and transmit data over a network.

17. The system of claim 16, wherein the power management circuitry to perform the first transition comprises the power management circuitry to:
disable each clock signal which is provided to the load circuit; and
after each clock signal which is provided to the load circuit is disabled, transition each supply voltage which is provided to the load circuit to a respective voltage range which enables a state of the load circuit to be maintained.

18. The system of claim 17, wherein:
during the second power state, each supply voltage which is provided to the load circuit is to be in a respective voltage range which enables an execution state of the processor core to be maintained, and which further prevents an execution of instructions by the one or more processor cores.

19. The system of claim 16, wherein:
the detector circuitry is further to receive a second indication of a change to the power demand, wherein the second indication is received during the second power state;
the detector circuitry is further to make a second determination, based on the second indication, that the power demand condition satisfies a second test criteria; and
based on the second determination, the power management circuitry is further to perform a second transition from the second power state, wherein the power management circuitry to perform the second transition comprises the power management circuitry to enable the functionality.

20. The system of claim 19, wherein the power management circuitry to perform the second transition further comprises the power management circuitry to:
enable the one or more clock signals; and
increase each of the one or more supply voltages.
